(19) United States
(12) Patent Application Publication
(10) Pub. No.: US 2007/0078908 A1
(43) Pub. Date: Apr. 5, 2007

(54) METHOD AND SYSTEM FOR CHILD SAFETY

(76) Inventors: Santu Rohatgi, Lutz, FL (US); Ryan R. Rohatgi, Lutz, FL (US); Peter W. Rung, Lutz, FL (US)

Correspondence Address: HOVEY WILLIAMS LLP, 2405 GRAND BLVD., SUITE 400, KANSAS CITY, MO, 64108, US

(21) Appl. No.: 11/383,573

(22) Filed: May 16, 2006

Related U.S. Application Data
(60) Provisional application No. 60/681,436, filed on May 17, 2005.

(51) Int. Cl. G06F 17/30

(52) U.S. Cl. 707/203

(57) ABSTRACT

A method and computer program for enhancing child safety in child care organizations involves registering a child and the child's guardian by receiving biometric data from the child and the guardian and storing the biometric data in a database. When an adult drops off or picks up the child, the program identifies the adult as an authorized guardian by receiving biometric data from the child and from the adult and comparing the newly-received biometric data with the biometric data stored in the database. The program further automatically logs event and status information associated with the child, such as check-in and check-out times.

### RELATED APPLICATION

The present application is a nonprovisional patent application and claims priority benefit, with regard to all common subject matter, of earlier-filed U.S. provisional patent application titled “METHOD AND SYSTEM FOR CHILD SAFETY”, Ser. No. 60/681,436, filed May 17, 2005. The identified earlier-filed application is hereby incorporated by reference into the present application.

### BACKGROUND OF THE INVENTION

1. Field of the Invention

The present invention relates to the field of child monitoring and safety in child care organizations and similar settings. More particularly, the present invention involves a method and computer program for biometrically securing transfer of responsibility for a child between a guardian and a child care organization and automatically logging event and status information of the child.

2. Description of Prior Art

Child care organizations, such as daycare centers, schools, and similar organizations, are responsible for ensuring that each child in their care is released only to an authorized guardian. In some environments, organization employees can get to know each child and each adult well enough to recognize a guardian relationship between a child and an adult. In organizations with a large number of children and/or employees, however, it is more difficult for employees to become acquainted with each child and adult well enough to remember guardian relationships. When multiple adults are authorized to collect children from a care organization, such as parents, siblings, and grandparents, it becomes even more difficult for employees to remember who is an authorized guardian of each child.

One method of solving this problem involves maintaining a list of people who are authorized to assume responsibility for each child. Unfortunately, referring to such a list can be time consuming because an employee has to retrieve the list, search the list for the adult's name, and confirm the identity of the adult. This process can be prohibitively time consuming if several adults need to be verified in a small amount of time.

Furthermore, such organizations may need to maintain updated records of such things as check-in, check-out, and status of one or more children. Traditional methods of maintaining these records are time consuming and subject to error.

Accordingly, there is a need for an improved system and method of child safety that does not suffer from the problems and limitations of the prior art.

### SUMMARY OF THE INVENTION

The present invention overcomes the problems and limitations of the prior art explained above with an improved method and computer program for enhancing child safety in child care organizations. Particularly, the present invention provides a method and computer program for biometrically securing transfer of responsibility for a child between a guardian and a child care organization and automatically logging event and status information of the child.

A first embodiment of the invention is a computer program for enabling a safety system, wherein at least a portion of the program is stored on a computer-usable medium. The computer program comprises a code segment for receiving biometric data from a first person, a code segment for receiving biometric data from a second person, and a code segment for determining whether the second person is an authorized guardian of the first person by comparing the biometric data from the first person and the biometric data from the second person with guardianship information identifying a guardian of the first person.

A second embodiment of the invention is a computer program for enhancing child safety at a child care organization. The computer program comprises code segments for registering a child by receiving biometric data and personal information from the child and storing the biometric data and personal information in a database, for registering an adult by receiving biometric data and personal information from the adult and storing the biometric data and personal information received from the adult in the database, and for registering a guardian relationship by associating the child's biometric data and personal information with the adult's biometric data and personal information.

The program is further operable to securely check the child into and out of the organization. The program checks the child into the organization by matching newly-received biometric data with the child's biometric data stored in the database, matching newly-received biometric data with the adult's biometric data stored in the database, and determining whether the adult is an authorized guardian of the child by comparing the adult's biometric information and the child's biometric information with the registered guardianship. The program checks the child out of the organization by matching newly-received biometric data with the child's biometric data stored in the database, matching newly-received biometric data with the adult's biometric data stored in the database, and determining whether the adult is an authorized guardian of the child by comparing the adult's biometric information and the child's biometric information with the registered guardianship.

The program also includes a code segment for maintaining a log of events associated with the child by storing a time, the child's personal information, and the adult's personal information associated with each of the check-in and check-out.

A second embodiment of the invention is a system for enhancing child safety at a child care organization, wherein the system comprises a biometric sensor, a computing device for receiving biometric data from the biometric sensor, and a computer-usable medium encoded with a computer program for enabling the computing device to implement a method of enhancing child safety.

The computer program comprises code segments for registering a first person by receiving biometric data from the first person via the biometric sensor, for registering a second person by receiving biometric data from the second person via the biometric sensor, and for registering a guardian relationship between the second person and the first person by associating the second person's biometric data with the first person's biometric data. The computer program further includes a code segment and for securing a transfer of responsibility of the first person between the second person and the organization by matching newly-received biometric data with the first person's biometric data, matching newly-received biometric data with the second person's biometric data, and confirming a guardian relationship between the second person and the first person by comparing the second person's biometric data and the first person's biometric data with the registered guardian relationship.

A fourth embodiment of the invention is a method of enhancing child safety in a child care organization. The method comprises registering a child by receiving electronic biometric data from the child, registering an adult by receiving electronic biometric data from the adult, and registering a guardian relationship between the adult and the child by associating the adult's biometric data with the child's biometric data. The method further comprises securing a transfer of responsibility for the child between the adult and the organization by using a computer to match newly-received biometric data with the child's biometric data, to match newly-received biometric data with the adult's biometric data, and to confirm a guardian relationship between the adult and the child by comparing the adult's biometric data and the child's biometric data with the registered guardian relationship.

These and other important aspects of the present invention are described more fully in the detailed description below.

### BRIEF DESCRIPTION OF THE DRAWINGS

An embodiment of the present invention is described in detail below with reference to the attached drawing figures, wherein:

FIG. 1 is a schematic diagram of an exemplary system for implementing a computer program in accordance with an embodiment of the present invention, wherein the program implements a method of securely transferring responsibility of a child between a guardian and a child care organization;

FIG. 2 is a flow diagram of certain steps performed by the computer program to register a child;

FIG. 3 is a flow diagram of certain steps performed by the computer program to register a guardian;

FIG. 4 is a flow diagram of certain steps performed by the computer program to create a guardianship between the guardian and the child;

FIG. 5 is a flow diagram of certain steps performed by the computer program to register an agent of the child care organization;

FIG. 6 is a flow diagram of certain steps performed by the computer program to securely transfer responsibility of the child from the guardian to the child care organization; and

FIG. 7 is a flow diagram of certain steps performed by the computer program to securely transfer responsibility of the child from the child care organization to the guardian.

### DETAILED DESCRIPTION

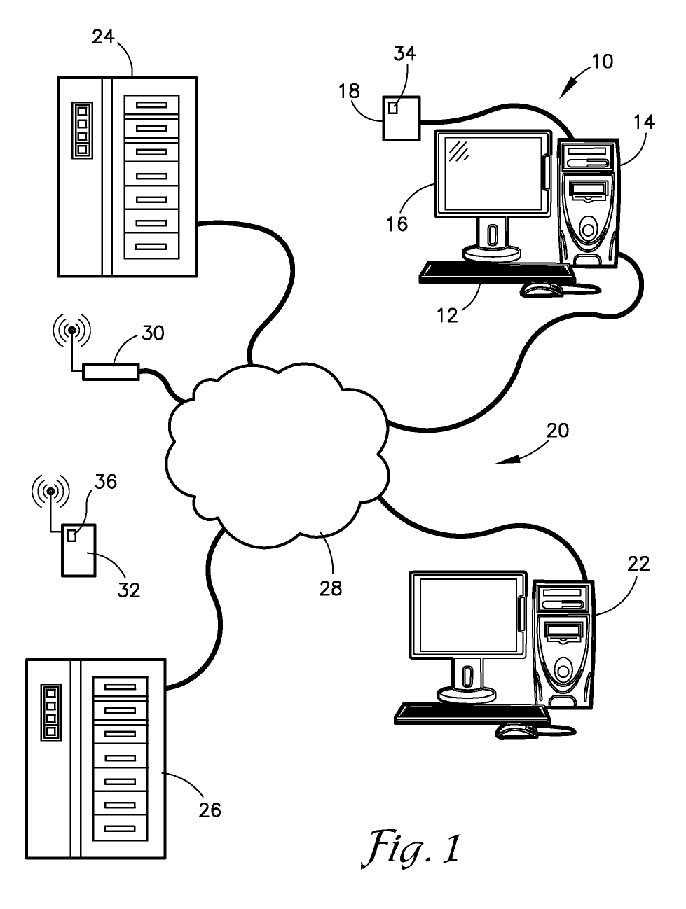

The present invention relates to a method and computer program for enhancing child safety in a child care organization by biometrically securing transfer of responsibility for a child between a guardian and the organization and automatically logging event and status information of the child. The method of the present invention is especially well-suited for implementation on a computer or computer network, such as the computer 10 illustrated in FIG. 1 that includes a keyboard 12, a processor console 14, a display 16, and one or more peripheral devices 18, such as an external data storage device, biometric data sensor, scanner, or printer.

The computer 10 may be a part of a computer network, such as the computer network 20 that includes one or more client computers 10,22 and one or more server computers 24,26 interconnected via a communications system 28. The present invention may also be implemented, in whole or in part, on a wireless communications system including, for example, a network-based wireless transmitter 30 and one or more wireless receiving devices, such as a hand-held computing device 32 with wireless communication capabilities. The method of the present invention makes use of biometric data which may be received via one or more biometric data sensors 34,36 associated with one or more computing devices, such as the computer 10 or the wireless device 32.

The present invention will be generally described herein as a computer program. It will be appreciated, however, that the principles of the present invention are useful independently of a particular implementation, and that one or more of the steps described herein may be implemented without the assistance of a computing device.

The present invention can be implemented in hardware, software, firmware, or a combination thereof. In a preferred embodiment, however, the invention is implemented with a computer program. The computer program and equipment described herein are merely examples of a program and equipment that may be used to implement the present invention and may be replaced with other software and computer equipment without departing from the scope of the present invention.

The computer program of the present invention is stored in or on a computer-useable medium, such as a computer-readable medium, residing on or accessible by a host computer for instructing the host computer to implement the method of the present invention as described herein. The host computer may be a server computer, such as server computer 24, or a network client computer, such as computer 10. The computer program preferably comprises an ordered listing of executable instructions for implementing logical functions in the host computer and other computing devices coupled with the host computer. The computer program can be embodied in any computer useable medium, such as a computer-readable medium, for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program” or “the computer program.” It will be understood by those skilled in the art that the program may comprise a single list of executable instructions or two or more separate lists, and may be stored on a single computer-useable medium or multiple distinct media. The program will also be described as comprising various “code segments,” which may include one or more lists, or portions of lists, of executable instructions. Code segments may include overlapping lists of executable instructions, that is, a first code segment may include instruction lists A and B, and a second code segment may include instruction lists B and C.

In the context of this application, a “computer-useable medium” can be any means that can contain, store, communicate, propagate or transport the program for use by or in connection with the instruction execution system, apparatus, or device. The computer-useable medium can be, for example, but not limited to, an electronic, magnetic, optical, electromagnetic infrared, or semi-conductor system, apparatus, device, or propagation medium. More specific, although not inclusive, examples of computer-useable media would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-useable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

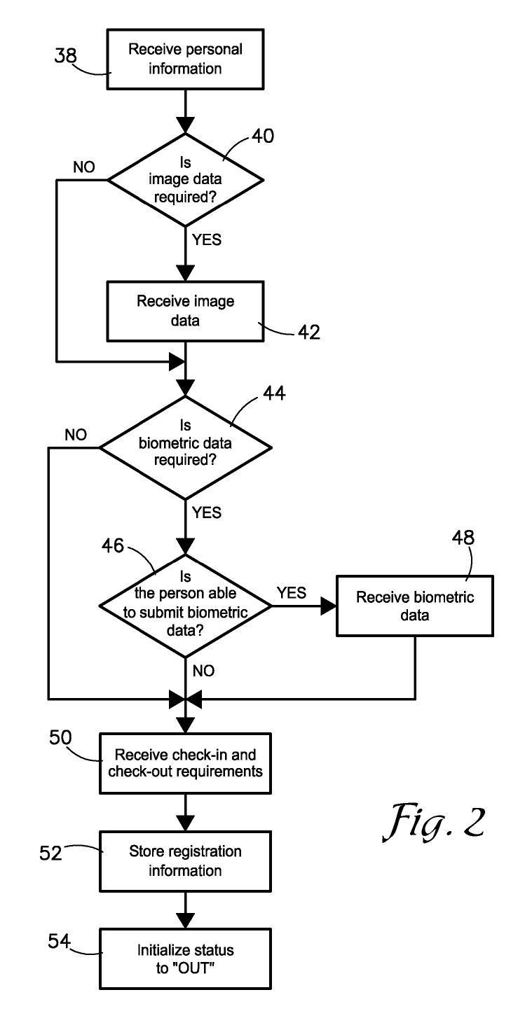

The method and computer program of the present invention biometrically secures transfer of responsibility for a child between a guardian and a child care organization and automatically logs event and status information of the child, such as child check-in and check-out. Biometrically securing transfer of responsibility for a child between the guardian and the organization generally involves registering the child, registration an adult, creating a guardian relationship between the adult and the child, checking agents of the organization (e.g., employees) in and out of the organization, and securing check-in and check-out of a child. FIGS. 2-7 illustrate various flow diagrams of steps associated with these processes, wherein at least a portion of the steps are executed by the computer program. It will be appreciated, however, that one or more steps of the illustrated flow diagrams may be implemented without the assistance of a computing device. Furthermore, one or more of the steps illustrated in the flow diagrams may be performed out of the order depicted. Two steps illustrated in sequence, for example, may be performed simultaneously or even in reverse order according to the situation.

An exemplary implementation of the method and computer program of the present invention is a child care center where parents transfer responsibility for children to the center in the morning and the center transfers responsibility for the children back to the parents in the afternoon or evening. While the invention will hereinafter be described according to this implementation, it will be appreciated that the invention is not so limited and that various other embodiments and implementations are within the ambit of the claimed invention. The invention may also be used in schools and in hospitals, for example, where a guardian must transfer responsibility for a child to the school or hospital, and/or must be present when the school or hospital releases the child. The invention may also be used in a nursing home or assisted living center where residents are in need of constant care or supervision due to age or disability.

It will therefore be understood by those skilled in the art that the invention is not limited to use with child care organizations, but is useful in any organization where responsibility for a first person is transferred between a second person and the organization, whether the first person is a child or adult. The term “guardian” as used herein is generally a person who is authorized to assume responsibility for another person, even if such authorization is limited in nature. Thus, as used in this document, “guardian” includes, but is not limited to, legal guardian, parent, grandparent, sibling or other relative, school bus driver, or a person authorized by a parent or legal guardian to take responsibility for a child. Certain steps of the method and program set forth below involve an agent of the child care organization. An agent of the organization is anyone with authority to act on behalf of the organization and includes, but is not limited to, an employee, volunteer, or principal of the organization.

Referring to FIG. 2, a flow diagram of steps involved in registering a child is illustrated. First, the program receives the child's personal information, as depicted in block 38. The personal information may include, for example, the child's name, social security number, address, phone number, and family information such as the name of a parent or guardian of the child. The program then determines whether image data of the child is required, as depicted in block 40. Guardians may be given the option, for example, of using image data, biometric data, both, or neither during check-in, check-out, or status update to verify the child's identity. The guardian may choose not to submit image data if only biometric data is used to confirm the child's identity. Alternatively, the guardian may choose to submit image data for emergency use only, regardless of whether it will be used to confirm the child's identity during routine procedures such as check-in and check-out.

If image data is required, the program receives the image data, as depicted in block 42, and includes the image data with the child's personal information. The image data may be captured, for example, using a digital camera or a scanning device.

The program determines whether the child's biometric data is required, as depicted in block 44. Biometric data may not be required, for example, where a guardian does not want the child's identity biometrically confirmed at any time. If the child's biometric data is required, the program determines whether the child is able to submit biometric data, as depicted in block 46. An agent of the organization may submit information indicating whether the child is able to submit biometric data, or the program may automatically determine whether the child is able to submit biometric data. The person being registered may not be able to submit biometric data, for example, if age or disability renders submission of the data difficult or impossible. A child may be too young, for example, or, where the invention is implemented in a nursing home or assisted care environment, a person may be too old.

If the child is able to submit biometric data, the program receives the biometric data, as depicted in block 48, via a biometric sensor, such as one of the sensors 36,34. The computer 10 may be placed at a check-in desk, for example, or one or more wireless handheld devices 32 with biometric sensors 36 may be used by agents of the organization to facilitate the check-in and check-out process. An exemplary method of submitting biometric data to the computer 10 or device 32 involves the child placing a finger on a fingerprint scanner and activating the scanner to capture fingerprint data, wherein the fingerprint scanner communicates the fingerprint data to the computer 10. It will be appreciated, however, that substantially any biometric data may be used without departing from the scope of the claimed invention including, but not limited to, voice print data, retinal scan data, iris scan data, facial characteristics, and behavioral characteristics, such as signature data, captured and analyzed using conventional hardware and processes known in the art. Furthermore, the biometric data used by the claimed invention may be any combination of one or more types of such biometric data.

The program receives check-in and check-out requirements, as depicted in block 50. The check-in and check-out requirements may be determined by a guardian of the child, an agent of the organization, or both and may include confirming the identity of the child, of a guardian, of an agent, or any combination thereof. The identity confirmation may include using biometric data, image data, or both. Alternatively, the requirements may not include identity confirmation at all, but may simply include logging an event time and names of people associated with the event, such as the child and a guardian.

The program then stores all of the information received from the child and guardian in a database, as depicted in block 52. All of the information is included in a profile of the child so that a user can retrieve, for example, personal information and image data by submitting the child's biometric data. Finally, the child's status is initialized to “OUT,” which means that the organization is not currently responsible for the child. The status is described in greater detail below.

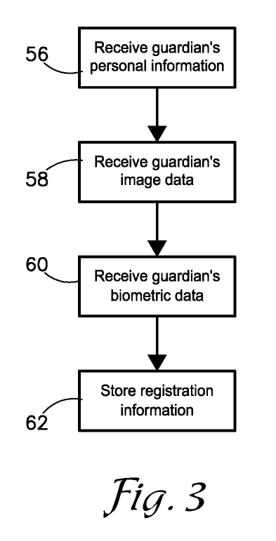

An exemplary process of registering a guardian is illustrated in FIG. 3. The program first receives the guardian's personal information, as depicted in block 56. Personal information may include, for example, the guardian's name, social security number, address, and phone number. The program then receives the guardian's image data, as depicted in block 58. The image data may be received in any one of various conventional manners including via a digital camera or scanning device. The program then receives the guardian's biometric data, as depicted in block 60, and stores the registration information in a database, as depicted in block 62.

The guardian's information is included in a profile of the guardian so that a user can retrieve, for example, personal information and image data by submitting the guardian's biometric data. The guardian's profile may be associated with the child's profile, as explained below, but the guardian's profile is generally maintained separately from the child's profile because. Separate maintenance of the profiles is important because, for example, a guardian may be associated with more than one child, and the guardian relationship between a child and the guardian may be terminated.

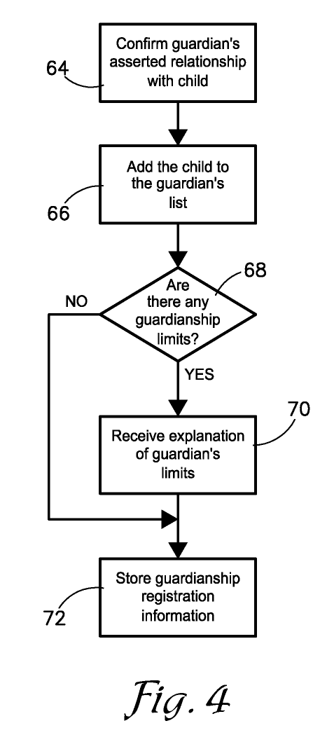

An exemplary process of registering a guardian relationship is illustrated in FIG. 4. Once a child and a guardian have been registered, the relationship between the guardian and the child is also registered to establish that the guardian has the right to perform such tasks as transfer responsibility for the child to the organization, assume responsibility of the child, and receive status information pertaining to the child. First, the guardian's asserted relationship is confirmed, as depicted in block 64. The guardian relationship will often be registered at the same time the guardian and child are registered, in which case confirming the asserted relationship may be as simple as reviewing a valid identification of the guardian, such as a driver's license. In some cases this step may be omitted entirely.

If a second guardian seeks to register a guardian relationship, the step of confirming the asserted relationship may be more involved. If an older sibling or a second parent of the child seeks to register the relationship, for example, confirming the asserted relationship may require reviewing a valid identification of the second guardian as well as contacting the original guardian to confirm that the original guardian consents to the addition of a second guardian, such as by a telephone call and/or a letter. The step of confirming the guardian's asserted relationship with the child is performed substantially independently of the program.

Each guardian may have a guardian relationship with several children, such as where the guardian is a parent with several children or is an older sibling with several younger siblings. The program maintains a list of children for each guardian. Therefore, when a guardian relationship is established, the program adds a child to the guardian's list, as depicted in block 66.

The program then determines whether there are any limits to the guardian relationship, as depicted in block 68. If so, the program receives an explanation of the guardianship limits, as depicted in block 70. Guardianship limits may relate to time or type of activities. A guardian relationship may be limited in time if, for example, a parent has custody of a child only on certain days, or if a sibling or grandparent checks the child out of the organization only on certain days of the week. Similarly, a guardian may be limited to only certain activities, such as checking a child into the organization (but not checking the child out), or receiving status reports of the child. Finally, all of the collected guardianship information is stored in the database, as depicted in block 72.

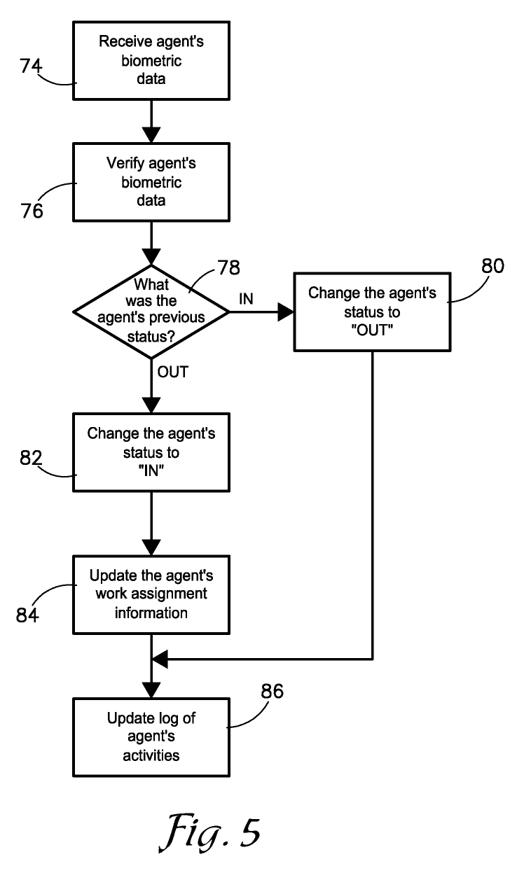

The organization may have many different agents who are authorized to on behalf of the organization, such as a child care organization with many employees authorized to check child into and out of the organization. To further secure transfers of responsibility for children between guardians and the organization, the program is operable to check agents of the organization into and out of service and log agent activity. An exemplary implementation of this concept is illustrated by the various steps of the flow diagram presented in FIG. 5. The agent is registered upon associating with the organization, such as where an employee is first hired and submits personal information. The initial agent registration may be substantially similar to the registration of the child or guardian, as described above.

When a registered agent is checked into or out of service, the program first receives the agent's biometric data, as depicted in block 74. The agent may submit, for example, fingerprint data via a standard fingerprint scanner 34 or 36 which is then communicated to a computing device running the program, such as the computer 10 or the wireless device 32. The program then verifies the agent's biometric data, as depicted in block 76. The program may verify the data by, for example, comparing the biometric data with biometric data stored in a database and determining whether the received biometric data matches any stored biometric data.

If the agent's biometric data is verified, the program determines the agent's previous status, as depicted in block 78. If the agent's previous status was “IN,” the program changes the agent's status to “OUT,” as depicted in block 80. If the agent's previous status was “OUT,” the program changes the agent's status to “IN,” as depicted in block 82. Furthermore, if the agent's status is changed to “IN,” the program updates the agent's work assignment information, as depicted in block 84. The work assignment information may be submitted by a person, such as the agent or a supervisor of the agent. Alternatively, the work assignment may be generated automatically by the program or by a program or computing device operating independently of the program of the present invention. Exemplary work assignments include a room or group of children at a daycare; a wing or department of a hospital or nursing home, and a group of residents of an assisted living center. The agent's work assignment may be updated each time it changes.

The program updates a log of the agent's activities, as depicted in block 86. The log may include such information as a time of each check-in, a time of each check-out, a current work assignment, and a history of work assignments. Guardians with authority to receive reports can receive information contained in the log of the agent's activities.

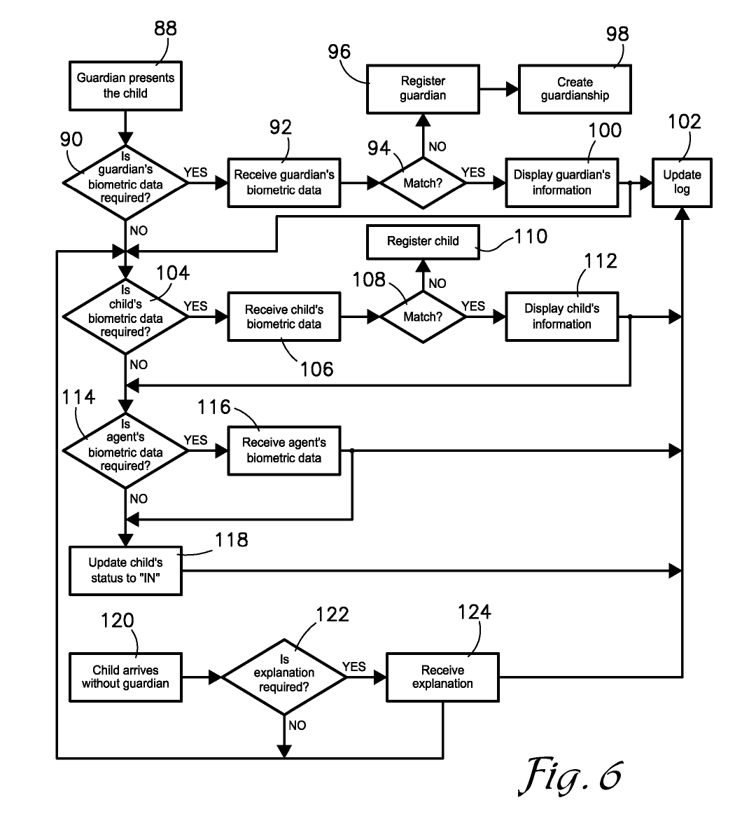

FIG. 6 illustrates a flow diagram of exemplary steps performed at the time of checking a child into the organization. Check-in generally involves transferring responsibility for a child from a guardian to the organization. A guardian or other person responsible for the child presents the child to an agent of the organization, as depicted in block 88. The program determines whether the guardian's biometric data is required, as depicted in block 90. Whether the guardian's biometric data is required is determined by a guardian at the time the child is registered, as explained above.

If the guardian's biometric data is required, the program receives the guardian's biometric data, as depicted in block 92. The guardian may submit, for example, fingerprint data via a standard fingerprint scanner 34 or 36 which is then communicated to a computing device running the program, such as the computer 10 or the wireless device 32. The program determines whether the received biometric data matches biometric data stored in a database, as depicted in block 94. If there is not a match, the program requires the guardian to register and create a guardian relationship, as depicted in blocks 96 and 98, and as explained above. If there is a match, the program displays the guardian's personal information, as depicted in block 100. The personal information may include the guardian's name, address, relationship to child, image, and so forth according to the check-in requirements associated with the child. Presenting the personal information, particularly the image data, enables the agent to perform an informal confirmation of the guardian relationship in addition to the confirmation performed by the program. The program updates the log with the name of the guardian, time of arrival, and similar information, as depicted in block 102.

The program determines whether the child's biometric data is required, as depicted in block 104. If so, the program receives the child's biometric data, as depicted in block 106, and determines whether the received biometric data matches biometric data stored in the database, as depicted in block 108. If there is not a match, the program requires the child to register, as depicted in block 110. If there is a match, the program displays the child's personal information, as depicted in block 112. If the child's biometric data is not required, the program receives the child's name or other piece of identifying information in order to update the event log with check-in information and the child's status.

The program determines whether the agent's biometric data is required, as depicted in block 114. Whether the agent's biometric data is required is determined by a guardian at the time the child is registered, as explained above. If the agent's biometric data is required, the program receives the agent's biometric data, as depicted in block 116. The agent may submit, for example, fingerprint data via a standard fingerprint scanner 34 or 36 which is then communicated to a computing device running the program, such as the computer 10 or the wireless device 32. The program verifies the agent's biometric data in a manner similar to that of the child and the guardian, and updates the log, as depicted in block 102. The program updates the child's status to “IN,” as depicted in block 118.

In certain situations a child may arrive at the organization without a guardian, as depicted in block 120. This may occur, for example, where a guardian drops the child off and leaves without attending check-in. When a child arrives for check-in without a guardian, the program determines whether an explanation is required, as depicted in block 122. Whether an explanation is required is determined at the time the child is registered, and is included in the check-in and check-out requirements. If there is more than one guardian associated with a child, for example, one of the guardians may request or require that an explanation always be provided when the child arrives at the school without a guardian. Alternatively, if there is only one guardian associated with the child, the guardian may deem it unnecessary to require an explanation.

If an explanation is required, the program receives the explanation, as depicted in block 124. The explanation may be as simple as a verbal explanation from the child that is submitted and stored in the event log, or may be a note from a parent that is scanned and stored in the event log. Because the explanation is associated with the event log, when the program presents a status of the child and a status history, the explanation will be available for users to review.

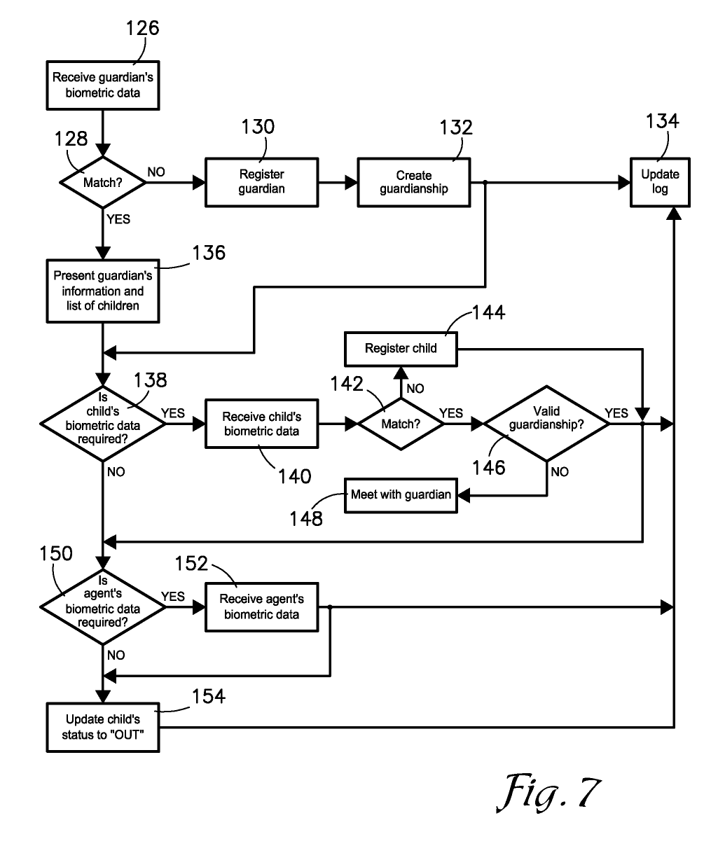

FIG. 7 illustrates a flow diagram of exemplary steps performed at the time of checking a child out of the organization. Checking a child out of the organization generally involves transferring responsibility for the child from the organization to a guardian. The program receives the guardian's biometric data, as depicted in block 126. The guardian may submit, for example, fingerprint data via a standard fingerprint scanner 34 or 36 which is then communicated to a computing device running the program, such as the computer 10 or the wireless device 32. The program determines whether the received biometric data matches biometric data stored in a database, as depicted in block 128. If there is not a match, the program requires the guardian to register and create a guardian relationship, as depicted in blocks 130 and 132, and as explained above. The program updates the event log with the information relating to the failed match and new registration, as depicted in block 134.

If the biometric data received from the guardian does match biometric data stored in the database, the program displays the guardian's personal information and a list of children associated with the guardian, as depicted in block 136. The personal information may include the guardian's name, address, relationship to child, image, and so forth according to the check-out requirements associated with the child. The list of children includes children with whom the guardian has a valid guardianship. The list may include a single child or several children, and the program enables a user to choose one or more children from a list of multiple children.

The program determines whether the child is required to submit biometric data, as depicted in block 138. If so, the program receives the child's biometric data, as depicted in block 140, and determines whether the received biometric data matches biometric data stored in the database, as depicted in block 142. If there is not a match, the program requires the child to register, as depicted in block 144. If there is a match, the program determines whether there is a valid guardianship linking the guardian and the child, as depicted in block 146. If there is not a valid guardianship, the program prompts human contact with the guardian, as depicted in block 148. Such contact may involve discussing the situation with the guardian, creating a new guardianship, etcetera.

If there is a valid guardianship, the program determines whether an agent must approve the check-out, as depicted in block 150. If an agent must approve the check-out, the program receives biometric data from the agent, as depicted in block 152. Once the child has been checked out, the program updates the child's status to “OUT,” as depicted in block 154.

As depicted in block 102 of FIG. 6 and block 134 of FIG. 7, the program is operable to automatically maintain a log of events associated with the child, such as the times a child is check into and out of the organization, whether or not a guardian was with the child at each check-in and check-out, and the identity of the guardian. Thus, the program eliminates the need for a person to manually maintain a record of such events and reduces the risk of human error.

By tracking check-in and check-out of the child, the program can maintain a status of the child as either “IN” or “OUT.” Other status information of the child may include location and health information. Location information may include a room or building identifier or other information if, for example, the child is participating in a field trip or is otherwise off the grounds of the care center. Health information may be important where the child has a health condition that requires monitoring by a health professional, such as a nurse or a doctor.

The status of the child may be updated by an agent of the organization, such as a teacher or monitor. The agent updates the status of a child using the computer 10, for example, and a guardian accesses the status information using the computer 22 or the wireless computing device 32 via the computer network 20. For example, the program may make the status information available via a website that is accessible via the computer network 20.

Although the invention has been described with reference to the preferred embodiments illustrated in the attached drawings, it is noted that equivalents may be employed and substitutions made herein without departing from the scope of the invention as recited in the claims.

Having thus described a preferred embodiment of the invention, what is claimed as new and desired to be protected by Letters Patent includes the following:

1. A computer program for enabling a safety system, at least a portion of the program being stored on a computer-usable medium, the computer program comprising:
a code segment for receiving biometric data from a first person;
a code segment for receiving biometric data from a second person; and
a code segment for determining whether the second person is an authorized guardian of the first person by comparing the biometric data from the first person and the biometric data from the second person with guardianship information identifying a guardian of the first person.

2. The computer program as set forth in claim 1, wherein the guardianship information includes previously-submitted biometric data associated with the first person, previously-submitted biometric data associated with the second person, and information describing a relationship between the first person and the second person.

3. The computer program as set forth in claim 1, further comprising a code segment for receiving and tracking status information of the first person.

4. The computer program as set forth in claim 3, wherein the status information includes information selected from the group consisting of check-in time, guardian present at check-in, check-out time, guardian present at check-out, location of the first person, and health of the first person.

5. The computer program as set forth in claim 3, further comprising a code segment for presenting the status information to the second person.

6. The computer program as set forth in claim 5, wherein the status information is presented to the second person electronically via a computer network.

7. The computer program as set forth in claim 1, further comprising a code segment for receiving information delineating limits to a guardianship of the second person and including the limits in the guardianship information.

8. The computer program as set forth in claim 7, wherein the limits to the guardianship include one or more time periods during which the second person is authorized to assume responsibility for the first person.

9. The computer program as set forth in claim 1, further comprising a code segment for receiving biometric data from a third person and determining whether the third person is an authorized agent of an organization that will assume responsibility for the first person.

10. The computer program as set forth in claim 1, wherein the biometric data is chosen from the group consisting of fingerprint data, voice print data, retinal scan data, iris scan data, facial characteristics, and signature data.

11. A computer program for enhancing child safety at a child care organization, at least a portion of the program being stored on a computer-usable medium, the computer program comprising:
a code segment for registering a child by receiving biometric data and personal information from the child and storing the biometric data and personal information in a database;
a code segment for registering an adult by receiving biometric data and personal information from the adult and storing the biometric data and personal information received from the adult in the database;
a code segment for registering a guardian relationship by associating the child's biometric data and personal information with the adult's biometric data and personal information;
a code segment for checking the child into the organization by matching newly-received biometric data with the child's biometric data stored in the database, matching newly-received biometric data with the adult's biometric data stored in the database, and determining whether the adult is an authorized guardian of the child by comparing the adult's biometric data and the child's biometric data with the registered guardianship;
a code segment for checking the child out of the organization by matching newly-received biometric data with the child's biometric data stored in the database, matching newly-received biometric data with the adult's biometric data stored in the database, and determining whether the adult is an authorized guardian of the child by comparing the adult's biometric data and the child's biometric data with the registered guardianship; and
a code segment for maintaining a log of events associated with the child by storing a time, the child's personal information, and the adult's personal information associated with each of the check-in and check-out.

12. The computer program as set forth in claim 11, further comprising a code segment for receiving status information of the child after the child is check in and before the child is checked out.

13. The computer program as set forth in claim 12, further comprising a code segment for communicating the status to the adult.

14. The computer program as set forth in claim 11, further comprising a code segment for receiving biometric data from a third person and determining whether the third person is an authorized agent of the care organization.

15. The computer program as set forth in claim 11, wherein the personal information of the child includes an image of the child, and wherein the personal information of the adult includes an image of the adult.

16. The computer program as set forth in claim 15, further comprising a code segment for checking the child into the organization by presenting the child's image, presenting the adult's image, and receiving a confirmation from an agent of the organization.

17. The computer program as set forth in claim 16, further comprising a code segment for allowing the adult to determine whether biometric data, image data, or both are used to check the child into and out of the organization.

18. The computer program as set forth in claim 11, further comprising a code segment for receiving information delineating limits to the guardian relationship.

19. The computer program as set forth in claim 18, wherein the limits to the guardian relationship include one or more time periods during which the adult is authorized to assume responsibility for the child.

20. A system for enhancing child safety at a child care organization, the system comprising:
a biometric sensor;
a first computing device for receiving biometric data from the biometric sensor; and
a computer-usable medium encoded with a computer program for enabling the first computing device to implement a method of enhancing child safety, the program comprising
a code segment for registering a first person by receiving biometric data from the first person via the biometric sensor,
a code segment for registering a second person by receiving biometric data from the second person via the biometric sensor,
a code segment for registering a guardian relationship between the second person and the first person by associating the second person's biometric data with the first person's biometric data, and
a code segment for securing a transfer of responsibility of the first person between the second person and the organization by matching newly-received biometric data with the first person's biometric data, matching newly-received biometric data with the second person's biometric data, and confirming a guardian relationship between the second person and the first person by comparing the second person's biometric data and the first person's biometric data with the registered guardian relationship.

21. The system as set forth in claim 20, wherein the computer program further comprises a code segment for creating and storing an event log including information associated with the transfer of responsibility and information associated with a status of the first person.

22. The system as set forth in claim 21, further comprising a second computing device for receiving the event log from the first computing device via a network communications medium and presenting event log information.

23. The system as set forth in claim 22, wherein the first computing device and the second computing device are each chosen from the group consisting of a computer workstation, a notebook computer, and a handheld computing device.

24. The system as set forth in claim 20, the computer program further comprising a code segment for receiving image data from the first person and image data from the second person.

25. The system as set forth in claim 24, the computer program further comprising a code segment for securing a transfer of responsibility for the first person between the second person and the organization by presenting the first person's image, presenting the second person's image, and receiving a confirmation from an agent of the organization.

26. The system as set forth in claim 25, the computer program further comprising a code segment for allowing the second person to determine whether biometric data, image data, or both are used to secure a transfer of responsibility for the first person between the second person and the organization.

27. The system as set forth in claim 20, further comprising a code segment for receiving biometric data from a third person and determining whether the third person is an authorized agent of the organization.

28. The system as set forth in claim 27, the computer program further comprising a code segment for allowing the second person to determine whether biometric data from an authorized agent of the organization is required to transfer responsibility for the first person between the second person and the organization.

29. A method of enhancing child safety in a child care organization, the method comprising:
registering a child by receiving electronic biometric data from the child;
registering an adult by receiving electronic biometric data from the adult;
registering a guardian relationship between the adult and the child by associating the adult's biometric data with the child's biometric data; and
securing a transfer of responsibility for the child between the adult and the organization by using a computer to match newly-received biometric data with the child's biometric data, to match newly-received biometric data with the adult's biometric data, and to confirm a guardian relationship between the adult and the child by comparing the adult's biometric data and the child's biometric data with the registered guardian relationship.

30. The method as set forth in claim 29, further comprising creating and storing an event log including information associated with the transfer of responsibility and information associated with a status of the child.

31. The method as set forth in claim 30, wherein said information associated with the status of the child is chosen from the group consisting of a check-in time, a guardian present at check-in, a check-out time, a guardian present at check-out, a location of the child, and health of the child.

32. The method as set forth in claim 31, further comprising receiving image data from the child and image data from the adult.

33. The method as set forth in claim 32, further comprising securing a transfer of responsibility of the child between the adult and the organization by presenting the child's image, presenting the adult's image, and receiving a confirmation from an agent of the organization.

34. The method as set forth in claim 33, further comprising allowing the adult to determine whether biometric data, image data, or both are used to secure a transfer of responsibility of the child between the adult and the organization.

35. The method as set forth in claim 29, further comprising receiving electronic biometric data from a third person and determining whether the third person is an authorized agent of the organization.
